(19) United States
(12) Patent Application Publication
(10) Pub. No.: US 2022/0354722 A1
(43) Pub. Date: Nov. 10, 2022

(54) Methods And Systems For Lengthening Telomeres

(71) Applicant: Eternal Youth, LLC, Vernal, UT (US)

(72) Inventor: Spencer James Nelson, Vernal, UT (US)

(73) Assignee: Eternal Youth, LLC, Vernal, UT (US)

(21) Appl. No.: 17/716,631

(22) Filed: Apr. 8, 2022

Related U.S. Application Data
(60) Provisional application No. 63/184,931, filed on May 6, 2021.

(51) Int. Cl. A61G 10/02; A63B 22/02; A62B 31/00

(52) U.S. Cl. CPC A61G 10/026; A63B 22/02; A62B 31/00

(57) ABSTRACT

The present disclosure relates to methods for lengthening telomeres. administering a hyperbaric oxygen therapy protocol; prescribing an exercise regimen that is performed inside of a hyperbaric chamber during the administration of the hyperbaric oxygen protocol; and prescribing a specialized nutrition plan comprising a daily intake of high fiber.

### BACKGROUND

Aging is characterized by the progressive loss of physiological capacity. At the cellular level, two key hallmarks of the aging process include telomere length shortening and cellular senescence. Telomeres are structures formed from a strand of DNA together with specialized proteins and located at the ends of chromosomes. While they do not contain genetic information themselves, they are vital for preserving the stability and integrity of chromosomes and the DNA that cells rely on to function. As individuals age, telomeres get shorter since each time a cell divides, part of the telomere is lost, so telomere length is seen as a marker of biological age. Telomeres are tandem nucleotide repeats located at the end of the chromosomes which maintain genomic stability. Telomeres shorten during replication, or mitosis, due to the inherent inability to fully replicate the end part of the lagging DNA strand. Telomere length, measuring between 4 to 15 kilobases, gradually shorten by about 20 to about 40 bases per year, and is associated with different diseases, low physical performance, and cortical thinning of the brain.

The length of the cell's telomeres shortens with every cell division and upon reaching a critical length, trigger the cell to either undergo the process of apoptosis (programmed cell death) or senescence (cells stop dividing and enter state of permanent growth arrest). This natural cycle indicates that cells possess a limited number of divisions. Telomeres, in essence, serve as a cell's “biological clock,” influencing the lifespan of the cell. The shorter the telomere, the shorter the remaining lifespan, and, in humans, shorter telomere length may be associated with an increased risk of chronic illness development, including Type-2 diabetes, cardiovascular disease, and certain forms of cancers.

When telomere length reaches a critical length, cells cannot replicate and progress to senescence or programmed cell death. In essence, as telomeres shorten, DNA becomes damaged, and cells stop replicating. At the same time, senescent cells build up in the body, preventing regeneration. Adults with shorter telomere lengths may have increased mortality rates. Shortened telomere lengths may be a direct inherited trait, but several environmental factors may also be associated with shortening telomere length, including stress, lack of physical endurance activity, excess body mass index, smoking, chronic inflammation, vitamins deficiency and oxidative stress. Oxidative stress appears to be the most common factor in shortening telomere length. Oxidative stress can occur from imbalances between the production or reactive oxygen species and cellular scavengers. Telomeres are highly sensitive to oxidative DNA damage, which may induce telomere shortening and dysfunction.

Cellular senescence is an arrest of the cell cycle which may be caused by telomere shortening, as well as other aging associated stimuli independent of telomere length such as non-telomeric DNA damage. The primary purpose of senescence is to prevent propagation of damaged cells by triggering their elimination via the immune system. The accumulation of senescent cells with aging reflects either an increase in the generation of these cells and/or a decrease in their clearance, which in turn aggravates the damage and contributes to aging.

### BRIEF DESCRIPTION OF THE DRAWINGS

FIG. 1 illustrates a cross-sectional side view of a hyperbaric chamber that contains exercise equipment, according to some embodiments disclosed herein.

FIG. 2A illustrates a front view of the hyperbaric chamber, according to some embodiments disclosed herein.

FIG. 2B is a top view of the floor of a hyperbaric chamber, according to some embodiments disclosed herein.

FIGS. 3A-3B illustrate plan views of a hyperbaric chamber comprising exercise equipment, according to some embodiments disclosed herein.

FIG. 4 depicts the process of chromosome cell division, according to some embodiments disclosed herein.

### DETAILED DESCRIPTION

The present disclosure provides methods and systems for increasing the length of telomeres using combination therapy comprising hyperbaric oxygen therapy (“HBOT”) protocols, exercise, and specialized nutrition. This combination of effective therapies may produce a maximizing effect on the lengthening of telomeres.

As disclosed herein, the HBOT is the use of oxygen in a hyperbaric chamber where the pressure may be above atmospheric pressure. In some examples, the pressure in the hyperbaric chamber may range from 1 atm to 2 atm. In some methods disclosed herein, the exercise regimen performed in the hyperbaric chamber may comprise high intensity interval training (“HIIT”), wherein HIIT may be performed concurrently while undergoing the HBOT protocol, while following a specialized nutrition plan comprising a high fiber diet. In some examples, exercise may be performed outside of the chamber. For example, an exercise regimen may be prescribed to be performed outside of the hyperbaric chamber to maintain results and health. The duration and frequency may vary depending upon the user. For example, the exercise regimen may be prescribed to be performed outside of the hyperbaric chamber for at least 30 minutes, three times a week.

The HBOT protocols, the exercise regimen, and the nutrition plan may be customized for each individual based on a plurality of physical factors including age, physical fitness level, and overall physical health. Similarly, the duration of the combination therapy may vary and may be specific to an individual based a plurality of factors including, but not limited to, age, physical activity level, obesity, whether the individual is a smoker or non-smoker, level of vitamin deficiency, and inflammation.

As disclosed herein, HBOT utilizes air with about 20% to about 100% oxygen in an environmental pressure higher than one absolute atmosphere to enhance the amount of oxygen dissolved in the body's tissues such as for example 1 to 2 atm. For purposes herein, “oxygen” may be defined as any gaseous form of the oxygen element. The source of oxygen utilized herein may be from liquid or gaseous sources.

An oxygen tank may be used to provide (e.g., via a valve) oxygen to a user exercising in the hyperbaric chamber. The chamber may have a diameter that ranges from 8 feet to 10 feet. In other examples, the chamber may be larger. The chamber may be of any suitable shape such as for example, a cube, a cylinder, a sphere, a prism. In some examples, the shape may resemble a propane tank. It should be noted that exercise equipment (e.g., treadmill, exercise/weight machines) may be disposed in a workout area of the chamber and that the chamber is of sufficient size to enable normal operation of the equipment therein.

Repeated intermittent hyperoxic exposures, using certain HBOT protocols, may induce physiological effects, which normally occur during hypoxia in a hyperoxic environment, the so-called hyperoxic-hypoxic paradox. In addition, HBOT may induce cognitive enhancements in healthy aging adults via mechanisms involving regional changes in cerebral blood flow. On the cellular level, HBOT may induce the expression of hypoxia induced factor (“HIF”), vascular endothelial growth factor (“VEGF”) and sirtuin (“SIRT”), stem cell proliferation, mitochondrial biogenesis, angiogenesis, and neurogenesis. Additionally, intermittent hyperoxic exposures may induce many of the physiological responses that may occur during hypoxia.

While many genetic and environmental factors may be associated with telomere shortening, the most common may be oxidative stress. Oxidative stress may occur from imbalances between the production of reactive oxygen species (“ROS”) and cellular scavengers. Telomeres may be highly sensitive to oxidative DNA damage, which may induce telomere shortening and dysfunction. Human cell culture studies consistently show that mild oxidative stress may accelerate telomere shortening, whereas antioxidants and free radical scavengers may decrease shortening rates and increase the cellular proliferative lifespan. There are correlations between pathological conditions (such as diabetes, inflammatory diseases, and Parkinson's disease) and oxidative stress markers, reactive oxygen species scavenger levels and telomere length.

HBOT protocol may vary, wherein the duration of each treatment protocol may be from about 30 minutes to about 2 hours at a frequency of 3 days to 5 days per week for approximately 3 weeks to 12 weeks, 4 weeks to 8 weeks, or 4 weeks to 6 weeks. As disclosed herein, HBOT may require breathing about 20% to about 100% pure oxygen inside a chamber filled with compressed air. The air pressure inside the chamber may be increased to 1 time to 3 times normal atmospheric pressure (e.g., 2 atm), 2 times to 5 times normal atmospheric pressure, or 2 times to 4 times normal atmospheric pressure. The extra pressure may increase blood oxygen to many times its normal level. The blood vessels may deliver this super-oxygenated blood to tissues throughout the body to help heal, fight infection, decrease swelling (edema), aid in growth of new blood vessels (capillaries), and lengthen telomeres. These benefits cannot be achieved by breathing normal amounts of oxygen in a regular room.

HBOT may inhibit active inflammation, in part by suppressing TNF-alpha, IL-1 and IL-6 and enhancing host antibacterial responses. Furthermore, HBOT may decrease neopterin, myeloperoxidase activity and oxidative stress markers, while stimulating angiogenesis. It may optimize fibroblast/collagen proliferation and white blood cell activity, otherwise limited during periods of hypoxia. HBOT may also control (e.g., decrease) blood pressure, and promote weight loss. In some non-limiting examples, a user age may range from 30-36 years of age.

The disclosed methods and systems also may include an exercise regimen. The exercise regimen may be performed inside the hyperbaric chamber during the HBOT protocol and may comprise HIIT. HIIT, also referred to as high-intensity intermittent exercise (HIIE) or sprint interval training (SIT), is a form of interval training, a cardiovascular exercise strategy alternating short periods of intense anaerobic exercise with less intense recovery periods, until too exhausted to continue. These intense workouts may last up to 30 minutes.

Alternatively, the workouts may last from about 15 minutes to about 30 minutes. The duration of the workout session may vary based on a participant's current fitness level. The intensity of HIIT may also depend on the duration of the session. HIIT workouts may provide improved athletic capacity and condition as well as improved glucose metabolism.

Generally, HIIT exercise sessions may comprise a warm-up followed by repetitions of high-intensity exercises separated by medium intensity exercises for recovery, then a cool-down period. The high-intensity exercise may be completed at near maximum intensity. The medium exercise may be completed at about 50% intensity. The number of repetitions and length of each exercise may depend on the specific exercise but may be as little as three repetitions with only about 15 seconds to about 30 seconds of intense exercise. The specific exercises performed during the high-intensity portions may vary. For example, HIIT may be done using a cycling ergometer, a rowing ergometer, running, or stair climbing.

Depending on one's level of cardiovascular development, the moderate-level intensity may be as slow as walking. A common formula may involve a 2:1 ration of work to recovery periods. For example, about 30 seconds to about 40 seconds of hard sprinting may be alternated with about 15 seconds to about 20 seconds of jogging or walking, repeated to failure. Regular endurance training may induce numerous physiologic adaptations that facilitate improved exercise tolerance and physical well-being, in large part by increasing the body's capacity to transport and utilize oxygen. HIIT workouts may provide increased benefits because they may produce results at the cellular level.

The aerobic activity essentially may enhance the way cells produce protein and since diminished protein synthesis is one of the most adverse signs of aging, this is quite notable. HIIT may be safer and better tolerated than moderate-intensity continuous exercise by some patients. HIIT may give rise to many short- and long-term central and peripheral adaptations, including, but not limited to, inducing substantial clinical improvements with beneficial effects on several important prognostic factors, such as peak oxygen uptake, ventricular function, and endothelial function. HIIT may also reverse signs of aging at the cellular level.

For the methods and systems disclosed herein, a consistent HIIT regimen may be defined as 3 days to 5 days per week. This level of consistency may result in mitochondrial capacity having an increase of about 45% to about 70%. Mitochondria and ribosomes are organelles that are important for metabolism and aerobic fitness but tend to deteriorate with age. Keeping these structures healthy may reverse some signs of age-related decline within cells. The greater a person's mitochondrial capacity, the greater capacity they may have to breathe in, transport, and utilize oxygen to perform physical exercise and maintain healthy cell function. Further, HIIT may provide cellular benefits that may, over time, have implications for maintaining muscle, aerobic fitness, and insulin sensitivity with aging.

In some embodiments, the exercise regimen may comprise both HIIT and strength training. HIIT may be combined with strength training and both may be performed concurrently with the HBOT protocol. In some embodiments, the combination of HIIT and strength training may be performed during each HBOT session. For example, a patient's exercise regimen while receiving HBOT may include alternating between HIIT and strength training during each session. For example, a patient's exercise regimen while receiving HBOT may include alternating days for either HIIT or strength training. More specifically, a patient's exercise regimen may include HIIT 2 days to 3 days per week, while strength training the remaining two to three days per week. Hence, both HIIT and strength training may be done on the same day, or they may be separated and performed on different days. HIIT exercise may be performed for a duration of 5 minutes to 45 minutes. Strength training may be performed for a duration of 20 minutes to one (1) hour. Both may be performed concurrently with HBOT.

A specialized nutrition plan may also be a part of the combination therapy disclosed herein for maximizing the lengthening of telomeres. Some foods and nutrients may contribute to longer telomeres and therefore reduce biologic aging, whereas others may account for shorter telomeres. According to some examples disclosed herein, a high fiber diet may be beneficial. According to other examples disclosed herein, a high fiber and high protein diet may be beneficial.

The daily high fiber recommendations may vary for women and men. For example, for women between the ages of 18 and 50, the daily high fiber recommendation may range from about 30 to about 35 grams. Whereas, the daily high fiber recommendation for women over the age of 50 may range from about 25 grams to about 35 grams. The daily high fiber recommendation for men between the ages of 18 and 50 may range from about 35 grams to about 40 grams; whereas the daily high fiber recommendation over the age of 50 may range from about 30 grams to about 40 grams.

High fiber foods may include, but may not be limited to, fruits such as apples with skin, fresh apricots, dried apricots, bananas, blueberries, cantaloupe, fresh figs, dried figs, grapefruit, oranges, fresh peaches, dried peaches, pears, plums, raisins, raspberries, and strawberries. High fiber foods may include, but may not be limited to, grains, beans, nuts and seeds such as almonds, black beans, bran cereal, brown rice, cashews, flax seeds, garbanzo beans, kidney beans, lentils, lima beans, oats, quinoa, whole wheat pasta, peanuts, pistachio nuts, pumpkin seeds, soybeans, sunflower seeds, and walnuts. Additionally, high fiber foods may include, but may not be limited to, vegetables such as avocado, beets, beet greens, bok choy, broccoli, brussels sprouts, cabbage, carrots, cauliflower, coleslaw, collard greens, corn, green beans, celery, kale, onions, peas, sweet peppers, air-popped popcorn, baked potato with skin, spinach, summer squash, sweet potato, swiss chard, tomato, winter squash, and zucchini.

Dietary fiber may reduce the risk of heart disease and premature death. Some of the health benefits associated with dietary fiber may be a result of the preservation of telomeres, or, in other words, reduced cell aging. Diet may contribute positively or negatively to inflammation and oxidative stress. Among the many dietary factors affecting inflammation and oxidative stress, fiber may be one of the most significant. Moreover, as blood glucose concentrations increase, levels of inflammation and oxidative stress increase. Fiber consumption may slow the absorption of sugars, lowering blood glucose levels, insulin resistance, and risk of diabetes significantly. Hence, high fiber intake may slow biologic aging and protect telomeres by reducing inflammation and oxidative stress caused by elevated blood sugar concentrations.

Fiber intake may be linearly related to telomere length. Higher levels of fiber consumption may be correlated with longer telomeres, suggesting that a high-fiber diet may account for reduced biologic aging. Nevertheless, consumption of specific nutrients rarely occurs in isolation. It is likely that individuals who consumed large amounts of fiber may also eat significant quantities of fruits, vegetables, and whole grains. Likewise, consumption of fruits, vegetables, and whole grains may be related to reduced disease and mortality. Some of the health benefits associated with consumption of fruits, vegetables, and whole grains may be due to high levels of fiber intake. Similarly, some of the biologic aging advantages ascribed to high fiber intake may be a result of high intake of fruits, vegetables, and whole grains. Diets high in fiber and diets with significant amounts of fruits, vegetables, and whole grains go hand in hand. Part of the association between fiber intake and biologic aging may be a function of differences in fruit, vegetable, and whole grain consumption. In some examples, a high fiber diet refers to a diet that meets or exceeds the Dietary Reference Intake (DRI) for dietary fiber.

Individual dietary factors may influence telomere length, positively or adversely. For example, the relationship between fiber intake per 1000 kcal and telomere length may be positive and linear: each 1-gram increment in fiber intake per 1000 kcal may be associated with an increase in telomere length of 8.3 bases. Each year of chronological age may be associated with a shortening of telomeres by 15.5 base pairs. Hence, high fiber intake may be a critical component of diet for long-term health and longevity. Higher consumption of vegetables may be significantly related to higher telomere length. There may be a direct association between the micronutrient content of diet and telomere length, especially important may be the role of antioxidant intake, particularly beta-carotene, on telomere length maintenance.

As stated above, a high fiber higher protein diet may also be beneficial. In reference to proteins, it should be noted that the recommended minimum daily intake of protein in grams is not equivalent to a daily intake of high protein in grams. However, similar to the high fiber daily intake, the recommended daily intake of high protein may vary for women and men. Further, the recommended daily intake of high protein may vary for women who are pregnant versus women who are not pregnant, and also may be different for lactating women. For example, the recommended minimum daily intake of protein for women ages 18 to 24 may be about 43 grams to about 46 grams of protein; for women ages 25 to 50 may be about 44 to about 50 grams of protein; and form women over the age of 50 about 47 grams to about 50 grams of protein. For pregnant women, the recommended minimum daily intake of protein may be about 56 grams to about 65 grams. Moreover, for lactating women, the recommended minimum daily intake of protein may be about 56 grams to about 65 grams. Whereas, for men ages 18 to 24, the recommended minimum daily intake of protein may be about 56 grams to about 59 grams; form men ages 25 to 50 may be about 56 grams to about 63 grams; and for men over the age of 50, about 54 grams to about 63 grams.

The daily high protein intake may be calculated by dividing an individual's ideal weight in half, where the resulting number is the individual's recommended daily high protein intake, according to the present disclosure. For example, a woman with an ideal weight of 140 pounds may target a high protein daily intake of 70 grams of protein per day. It should be noted that individuals who may be diabetic or who may have kidney disease may need less protein.

High protein foods may include, but may not be limited to, beans such as black beans, garbanzo beans, kidney beans, lentils, lima beans, navy beans, soybeans, and tofu. High protein foods may also include, but may not be limited to, dairy such as cheddar cheese, cottage cheese, eggs, milk, muenster cheese, swiss cheese, and yogurt. High protein foods may also include, but may not be limited to, grains such as oatmeal, buckwheat pancakes, whole wheat pancakes, air-popped popcorn, quinoa, brown rice, rye bread, and whole wheat bread. Moreover, high protein foods may include, but may not be limited to, fish and poultry such as anchovies, halibut, mackerel, salmon, sardines, tuna, chicken (without skin), and turkey (without skin).

In some aspects of this disclosure, a method for lengthening telomeres may comprise administering a hyperbaric oxygen therapy protocol; implementing an exercise regimen; and prescribing a specialized nutrition plan, wherein the hyperbaric oxygen therapy protocol may be administered inside of a pressurized hyperbaric chamber, and wherein the exercise regimen may be implemented inside of the pressurized hyperbaric chamber during the administration of the hyperbaric oxygen therapy protocol.

In some aspects of this disclosure, a method for lengthening telomeres may comprise administering a hyperbaric oxygen therapy protocol; implementing an exercise regimen, wherein the exercise regimen comprises high intensity interval training; and prescribing a specialized nutrition plan, wherein the specialized nutrition plan comprises a high fiber diet; wherein the hyperbaric oxygen therapy protocol is administered inside of a pressurized hyperbaric chamber, and wherein the exercise regimen is implemented inside of the hyperbaric chamber during the hyperbaric oxygen therapy protocol.

In some aspects of this disclosure, a method for lengthening telomeres may comprise administering a hyperbaric oxygen therapy protocol for a period of about 30 minutes to about 2 hours; implementing an exercise regimen, wherein the exercise regimen comprises high intensity interval training and strength training; and prescribing a specialized nutrition plan, wherein the specialized nutrition plan comprises a high fiber diet; wherein the hyperbaric oxygen therapy protocol is administered inside of a pressurized hyperbaric chamber, and wherein the exercise regimen is implemented inside of the hyperbaric chamber during the hyperbaric oxygen therapy protocol.

Aspects of this disclosure are also directed to a system for lengthening telomeres, wherein the system may comprise a hyperbaric chamber; an exercise regimen; and a specialized nutrition plan; wherein the hyperbaric chamber may be pressurized in excess of 1 atmosphere, wherein the hyperbaric chamber may have exercise equipment stationed therein, and wherein the exercise regimen may be performed inside of the pressurized hyperbaric chamber.

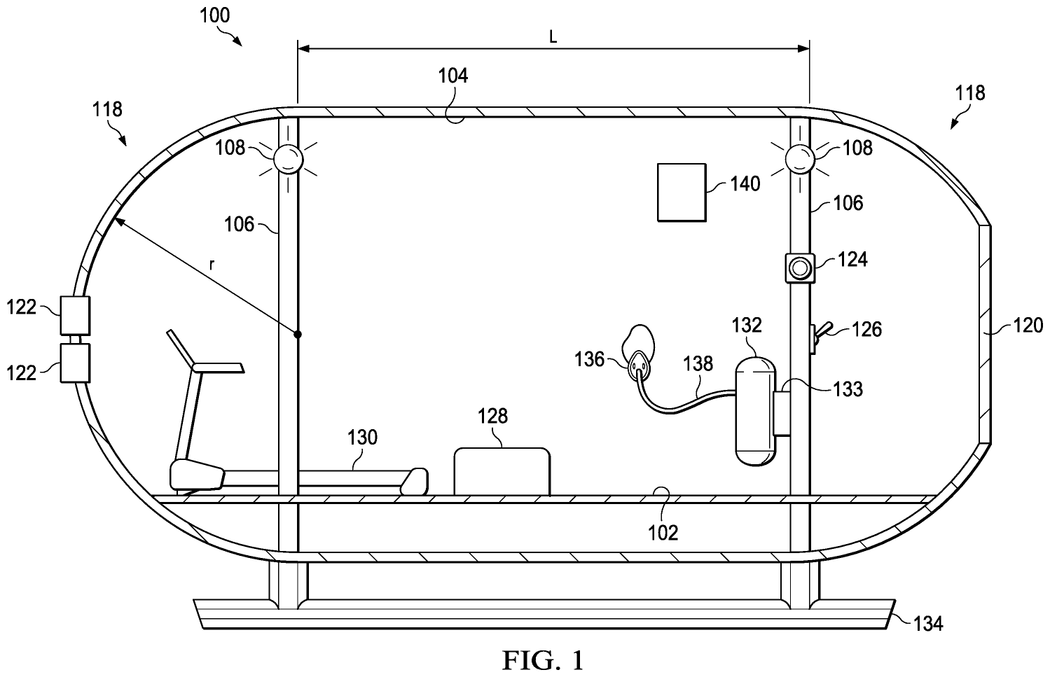

Example methods and systems for lengthening telomeres will now be described in more detail with reference to FIGS. 1-3. FIG. 1 illustrates a plan view of a hyperbaric chamber 100.

FIG. 1 illustrates a hyperbaric chamber 100, according to some embodiments disclosed herein. The shapes and sizes of the chamber 100 may comply with safety regulations. The hyperbaric chamber 100 may be sufficiently sized to accommodate exercise equipment that may be found in commercial gyms, for example. In some examples, height h may be at least 8 feet such as from 8 feet to 10 feet from a floor 102 that is inside the chamber 100, to a ceiling 104 of the chamber 100. The chamber 100 may include a shape that resembles a propane tank. In some examples, support members 106 may extend vertically from the floor 102 to the ceiling 104. Length L is the distance between the member 106. L may be at least 10 feet (e.g., 10 to 12 feet) for example. A light 108 may be positioned toward a top of each member 106 to illuminate the interior of the chamber 100.

The chamber 100 may also include end portions 118 which may each include a curved profile (e.g., hemisphere). Radius r from the center of each member 106 to an interior wall of the chamber 100 may be at least 4 feet (e.g., 4 feet to 6 feet). A door 120 may be disposed in one of the end portions 118. The door 120 may have a height ranging from 40 to 50 inches (e.g., 42 inches).

The chamber 100 may also include equipment 122 for controlling pressure within the chamber 100 (e.g., a computer, compressor, gauges, at least two air inlets, at least two pressure relief valves), and an emergency compressor cut-off switch 124, and a power switch 126 for controlling power to the chamber 100. Power may be supplied from a power source such as a grid. Duplicate components may be provided to ensure usage of the chamber 100 while replacing broken components.

A heater 128 may also be disposed in the chamber 100 for climate control. A treadmill 130 may also be positioned inside the chamber 100. An air tank 132 may be disposed in the chamber 100 to provide oxygen/air for the chamber 100. The tank 132 may be supported by a support stand 133 that may be attached to a member 106. The chamber 100 may be disposed on a support skid 134. In some examples, a mask 136 may be worn by a user to receive oxygen from the tank 132 via line 138. The mask 136 in concert with the tank 132 may allow for a safe usage of oxygen within the chamber 100 (as opposed to oxygen being pumped directly into the chamber 100 which may create a fire/explosion hazard). The mask 136 allows electrical equipment to be used safely within the chamber 100 (e.g., no need for purging of equipment to prevent explosions). The position of the tank 132 within the chamber 100 may also allow a user to access the tank 132 for adjustment of the flow of oxygen to the mask 136. A device 140 for heart monitoring or pulse oximetry may also be used within the chamber 100. In some examples, the tank 132 may be disposed outside of the chamber 100.

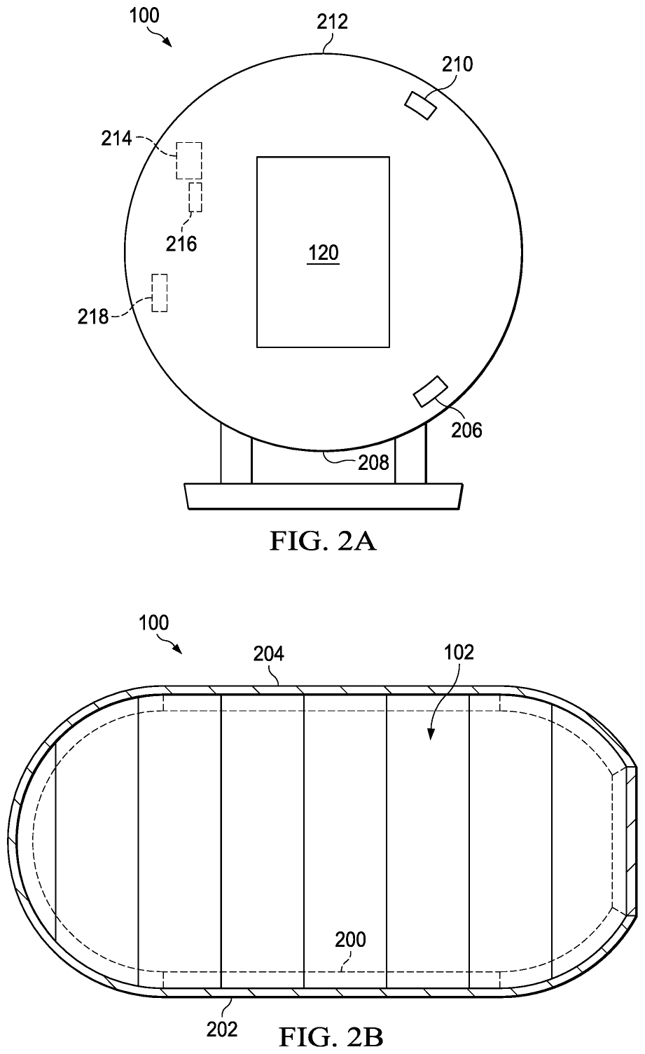

FIG. 2A illustrates a front view of the hyperbaric chamber 100, according to some embodiments disclosed herein. In some examples, the interior dimensions of hyperbaric chamber 100 may range from about 32 square feet to about 100 square feet. Alternatively, the interior dimensions of hyperbaric chamber 100 may range from about 32 square feet to about 100 square feet, about 40 square feet to about 90 square feet, about 50 square feet to about 80 square feet, or about 60 square feet to about 70 square feet. Once an individual (not shown) has entered into the hyperbaric chamber 100, the hyperbaric chamber 100 may be closed by sealing the door 120. The floor 102 of the hyperbaric chamber 100 is depicted in FIG. 2B, indicating a 2-inch box tube 200 about the perimeter of the floor 102.

FIG. 2B depicts both the front side 202 and the back side 204 of the floor 102. The hyperbaric chamber 100 may be flushed with oxygen at a relatively slow rate for the purpose of minimizing turbulence. In some embodiments, the desired flow rate may be from about 1.1 atmosphere to about 2 atmospheres. Since oxygen is heavier than air (1.429 kg/m³ versus 1.225 kg/m³), the hyperbaric chamber 100 may be filled through an inlet 206 proximate the bottom 208 of the hyperbaric chamber 100, while residual air may be vented from the hyperbaric chamber 100 using a vent 210 proximate the top side 212 of the hyperbaric chamber 100. This may reduce turbulence, thereby creating a quasi-laminar flow of oxygen from the bottom 208 to the top 212 of the hyperbaric chamber 100.

The pressure and percentage of oxygen in the hyperbaric chamber 100 may be measured continuously (e.g., via a sensor 214 and a computer 216) and may be calibrated continuously until the desired pressure is reached, as shown on FIG. 2A. After the desired or prescribed pressure level is reached, a hyperbaric chamber session timer 218 may start. The hyperbaric chamber session (e.g., time) may be continuously monitored. Other variables that may be continuously monitored may include temperature, carbon dioxide level, humidity levels, biometric data, and any other variables or conditions known in the art.

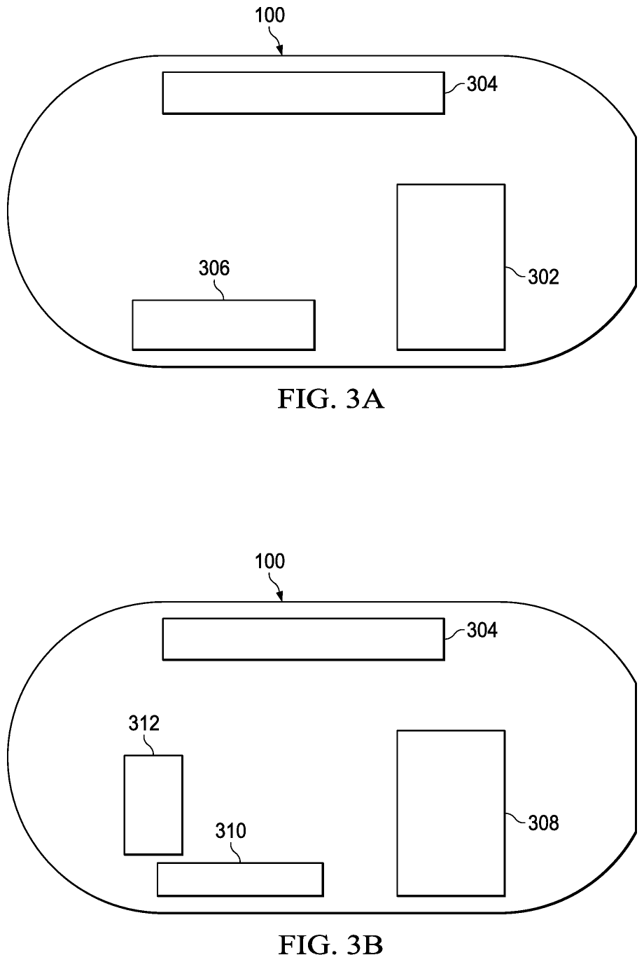

FIGS. 3A and 3B illustrate plan views of the hyperbaric chamber 100 comprising exercise equipment, according to some embodiments disclosed herein. FIG. 3A depicts the hyperbaric chamber 100 having a treadmill 302, resistance equipment 306, and a pull-up bar 304 disposed within workout area(s) (e.g., portion(s) of the floor within the chamber). FIG. 3B depicts the hyperbaric chamber 100 having a plurality of cardio exercise equipment 308 disposed therein, wherein the plurality of equipment may include, but may not be limited to a treadmill, a stationary bike, a stair climber, and combinations thereof. The hyperbaric chamber 100 also includes a pull-up bar 304, a resistance hook 310, and a chair 312 disposed therein. The variety of exercise equipment may be used with the HIIT workout.

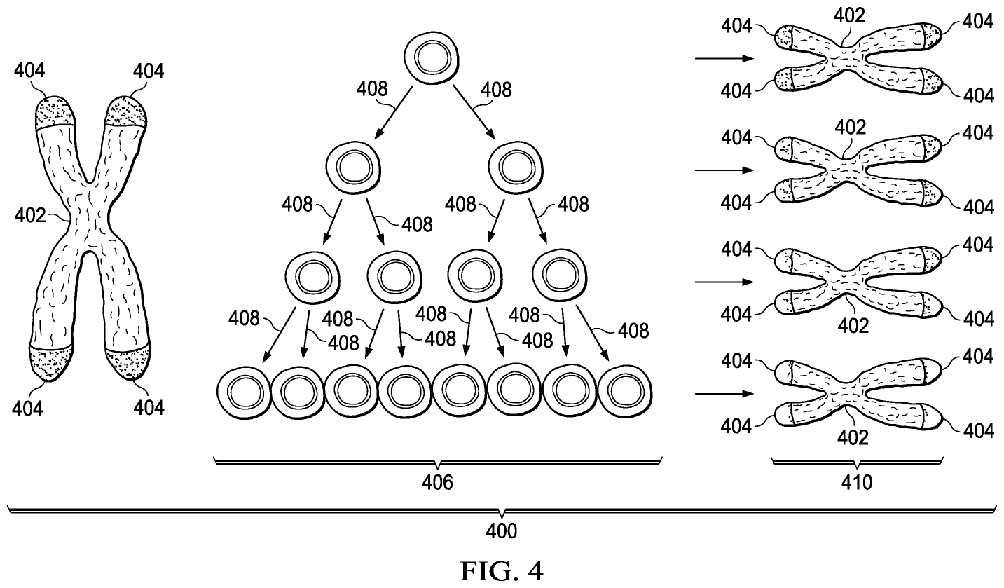

FIG. 4 depicts the process 400 of chromosome cell division, according to some embodiments disclosed herein. As shown in FIG. 4, telomeres 404 are repetitive nucleotide sequences at each end of a chromosome 402. The function of telomeres 404 is to protect the ends of chromosome 402 from deterioration or fusion to other chromosomes during cell division 406, wherein cell division 306 is shown by arrows 408. With every cell division 406, telomeres 404 shorten, as shown by divided chromosomes 410. The shortened telomeres 404, as shown in divided chromosomes 410 may block further cell division and induce senescence.

The methods and systems may include any of the various features disclosed herein, including one or more of the following statements.

Statement 1. A method of lengthening telomeres may be disclosed. The method may include administering a hyperbaric oxygen therapy protocol; prescribing an exercise regimen that is performed inside of a hyperbaric chamber during the administration of the hyperbaric oxygen protocol; and prescribing a specialized nutrition plan comprising a daily intake of high fiber.

Statement 2. The method of statement 1, wherein the hyperbaric oxygen therapy protocol is administered for a duration of about 30 minutes to about 2 hours.

Statement 3. The method of statement 1 or statement 2, wherein the hyperbaric oxygen therapy protocol is administered for a duration of about 60 minutes to about 90 minutes.

Statement 4. The method of any one of the preceding statements, wherein the exercise regimen comprises high intensity interval training performed for a duration of about 15 minutes to about 1 hour.

Statement 5. The method of any one of the preceding statements, wherein the exercise regimen comprises strength training performed for a duration of about 15 minutes to about 1 hour.

Statement 6. The method of any one of the preceding statements, wherein the exercise regimen comprises a combination of high intensity interval training and strength training performed for a duration of about 15 minutes to about 1 hour.

Statement 7. The method of any one of the preceding statements, wherein the specialized nutrition plan further comprises a daily intake of high protein, wherein the daily intake of high protein is about 43 grams to about 67 grams of protein per day.

Statement 8. The method of any one of the preceding statements, wherein the daily intake of high fiber is about 25 grams to about 40 grams of fiber per day.

Statement 9. The method of any one of the preceding statements, wherein the hyperbaric chamber is pressurized from 1 to 3 times atmospheric pressure.

Statement 10. The method of any one of the preceding statements, prescribing an exercise regimen to be performed outside of the hyperbaric chamber for at least 30 minutes, three times per week.

Statement 11. A system comprising: a hyperbaric chamber; exercise equipment disposed in the hyperbaric chamber; and an oxygen tank disposed in the hyperbaric chamber.

Statement 12. The system of statement 11, wherein a mask is disposed in the hyperbaric chamber.

Statement 13. The system of any one of statements 11 or 12, wherein the hyperbaric chamber includes a vertical door with a height ranging from 40 inches to 50 inches.

Statement 14. The system of any one of statements 11-13, wherein a height of the hyperbaric chamber is at least 8 feet.

Statement 15. The system of any one of statements 11-14, further comprising a workout area for the exercise equipment.

Statement 16. The system of any one of statements 11-15, wherein the exercise equipment includes cardio equipment.

Statement 17. The system of any one of statements 11-16, wherein the hyperbaric chamber comprises vertical support members.

Statement 18. The system of any one of statements 11-17, wherein the hyperbaric chamber comprises lights.

Statement 19. The system of any one of statements 11-18, wherein lights are disposed in the vertical support members.

Statement 20. The system of any one of statements 11-19, wherein the hyperbaric chamber includes vents.

For the sake of brevity, only certain ranges are explicitly disclosed herein. However, ranges from any lower limit may be combined with any upper limit to recite a range not explicitly recited, as well as ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The examples disclosed above are illustrative only, as the present embodiments may be modified and practiced in different but equivalent manners apparent to those skilled in the art having the benefit of the teachings herein. Although individual examples are discussed, the present disclosure covers all combinations of all those examples. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the illustrative examples disclosed above may be altered or modified and all such variations are considered within the scope and spirit of the present disclosure. If there is any conflict in the usages of a word or term in this specification and one or more patent(s) or other documents that may be incorporated herein by reference, the definitions that are consistent with this specification should be adopted.

What is claimed is:

1. A method comprising:
administering a hyperbaric oxygen therapy protocol;
prescribing an exercise regimen that is performed inside of a hyperbaric chamber during the administration of the hyperbaric oxygen protocol; and
prescribing a specialized nutrition plan comprising a daily intake of high fiber.

2. The method of claim 1, wherein the hyperbaric oxygen therapy protocol is administered for a duration of about 30 minutes to about 2 hours.

3. The method of claim 1, wherein the hyperbaric oxygen therapy protocol is administered for a duration of about 60 minutes to about 90 minutes.

4. The method of claim 1, wherein the exercise regimen comprises high intensity interval training performed for a duration of about 15 minutes to about 1 hour.

5. The method of claim 1, wherein the exercise regimen comprises strength training performed for a duration of about 15 minutes to about 1 hour.

6. The method of claim 1, wherein the exercise regimen comprises a combination of high intensity interval training and strength training performed for a duration of about 15 minutes to about 1 hour.

7. The method of claim 1, wherein the specialized nutrition plan further comprises a daily intake of high protein, wherein the daily intake of high protein is about 43 grams to about 67 grams of protein per day.

8. The method of claim 1, wherein the daily intake of high fiber is about 25 grams to about 40 grams of fiber per day.

9. The method of claim 1, wherein the hyperbaric chamber is pressurized from 1 to 3 times atmospheric pressure.

10. The method of claim 1, prescribing an exercise regimen to be performed outside of the hyperbaric chamber for at least 30 minutes, three times per week.

11. A system comprising:
a hyperbaric chamber;
exercise equipment disposed in the hyperbaric chamber; and
an oxygen tank disposed in the hyperbaric chamber.

12. The system of claim 11, wherein a mask is disposed in the hyperbaric chamber.

13. The system of claim 11, wherein the hyperbaric chamber includes a vertical door with a height ranging from 40 inches to 50 inches.

14. The system of claim 11, wherein a height of the hyperbaric chamber is at least 8 feet.

15. The system of claim 11, further comprising a workout area for the exercise equipment.

16. The system of claim 11, wherein the exercise equipment includes cardio equipment.

17. The system of claim 11, wherein the hyperbaric chamber comprises vertical support members.

18. The system of claim 17, wherein the hyperbaric chamber comprises lights.

19. The system of claim 18, wherein lights are disposed in the vertical support members.

20. The system of claim 11, wherein the hyperbaric chamber includes vents.
